(19) United States
(12) Patent Application Publication
(10) Pub. No.: US 2025/0135915 A1
(43) Pub. Date: May 1, 2025

(54) BIOMETRIC IDENTIFICATION FOR BATTERIES FOR ELECTRIC WORK VEHICLES

(71) Applicant: Caterpillar Inc., Peoria, IL (US)

(72) Inventors: Thomas L. TWIGGER, Spalding (GB); Steven GAHLINGS, Great Cambourne (GB)

(73) Assignee: Caterpillar Inc., Peoria, IL (US)

(21) Appl. No.: 18/694,207

(22) PCT Filed: Sep. 30, 2022
(86) PCT No.: PCT/US2022/077359

§ 371 Date: Mar. 21, 2024

(30) Foreign Application Priority Data
Oct. 26, 2021 (GB) 2115396.0

(51) Int. Cl. B60L 50/64; B60L 53/80; B60R 25/25; H01M 10/42; H01M 50/572

(52) U.S. Cl. CPC B60L 50/64; B60L 53/80; B60R 25/252; H01M 10/425; H01M 50/572; H01M 2220/20

(57) ABSTRACT

A method of securing a battery for an electric work vehicle, the battery comprising a biometric identification device. A biometric identifier is collected from an operator using the biometric identification device. The biometric identifier is checked against a list of authorized operators. In an event that the operator matches an authorized operator from the list of authorized operators, access to the battery is enabled such that the operator is able to use the battery; remove the battery from the electric work vehicle and a charging module; and mount the battery into the electric work vehicle. In an event that the operator does not match an authorized operator from the list of authorized operators, access to the battery is prevented such that the operator is prevented from using the battery; removing the battery from the electric work vehicle and a charging module; and mounting the battery into the electric work vehicle.

### FIELD

The disclosure relates to the field of electric work vehicles.

### BACKGROUND

Electric work vehicles comprise expensive, removable assets such as batteries. Batteries may belong to the owner of the electric work vehicle, or may be rented from another company on a subscription basis. Where multiple electric work vehicles are in use, operated by multiple operators, batteries may be moved between electric work vehicles or replaced entirely. This may pose issues in managing battery performance, or in maintaining security of any loose batteries on the work site.

### SUMMARY

Against this background, there is provided a method of securing a battery for an electric work vehicle, the battery comprising a biometric identification device. The method comprises collecting a biometric identifier from an operator using the biometric identification device. The method further comprises checking the biometric identifier against a list of authorized operators. In an event that the operator matches an authorized operator from the list of authorized operators, the method further comprises enabling access to the battery such that the operator is able to: use the battery; remove the battery from the electric work vehicle, mount the battery into the electric work vehicle, and connect the battery to and disconnect the battery from a charging module. In an event that the operator does not match an authorized operator from the list of authorized operators, the method further comprises preventing access to the battery such that the operator is prevented from: using the battery; removing the battery from the electric work vehicle; mounting the battery into the electric work vehicle; and connecting the battery to and disconnecting the battery from the charging module. The method further comprises detecting access to the battery and transmitting a notification of unauthorized access in the event that access is detected and: a biometric identifier has not been collected; or the collected biometric identifier does not match an authorized operator from the list of authorized operators.

There is also provided a security device for a battery for an electric work vehicle, the security device comprising a biometric identification device. The security device is configured to collect a biometric identifier from an operator using the biometric identification device. The security device is further configured to check the biometric identifier against a list of authorized operators. In the event that the operator matches an authorized operator from the list of authorized operators, the security device is further configured to enable access to the battery such that the operator is able to: use the battery; remove of the battery from the electric work vehicle and a charging module; and mount of the battery into the electric work vehicle. In the event that the operator does not match an authorized operator from the list of authorized operators, the security device is further configured to prevent access to the battery such that the operator is prevented from: using the battery; removing the battery from the electric work vehicle and a charging module; and mounting the battery into the electric work vehicle. The security device is further configured to detect access to the battery and transmitting a notification in the event that: a biometric identifier has not been collected; or the collected biometric identifier does not match an authorized operator from the list of authorized operators.

In this way, a battery for an electric work vehicle can be accessed only by authorized operators. If access is not enabled, the battery is disabled when unmounted and is prevented from being removed from an electric work vehicle, removed from a charging module, or mounted on an electric work vehicle.

### BRIEF DESCRIPTION OF THE DRAWINGS

A specific embodiment of the disclosure will now be described, by way of example only, with reference to the accompanying drawings in which:

FIG. 1 shows a flowchart illustrating a method of securing a battery for an electric work vehicle according to an embodiment of the present disclosure

### DETAILED DESCRIPTION

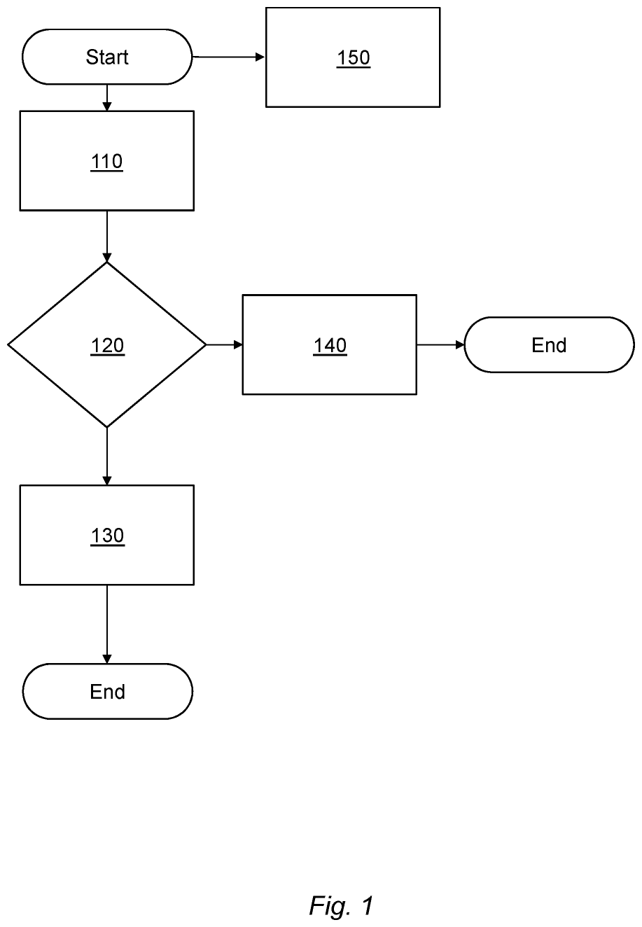

With reference to FIG. 1, a method of securing a battery for an electric work vehicle is illustrated. The battery comprises a biometric identification device. At step 110, a biometric identifier is collected from an operator using the biometric identification device. At step 120, the biometric identifier is checked against a list of authorized operators. In an event that the operator matches an authorized operator from the list of authorized operators, at step 130 access to the battery is enabled. In an event that the operator does not match an authorized operator from the list of authorized operators, at step 140 access to the battery is prevented. The method further comprises step 150 of detecting access to the battery and transmitting a notification of unauthorized access in the event that access is detected.

In the event that access to the battery is enabled for an operator, the operator is able to use the battery. The operator is also able to remove the battery from the electric work vehicle, and mount the battery into the electric work vehicle. The operator is also able to connect the battery to or disconnect the battery from a charging module. In an embodiment, the operator is also able to initialize charging once the battery has been connected to the charging module. The operator is therefore permitted to use the battery in an electric work vehicle, charge the battery, remove it from the electric work vehicle, and remove it from a charging module.

In the event that access to the battery is not enabled for an operator, the operator is prevented from using the battery. The operator is also prevented from removing the battery from the electric work vehicle, and mounting the battery into the electric work vehicle. The operator is also prevented from connecting the battery to or disconnecting the battery from a charging module. In an embodiment, the operator is also prevented from initializing charging in an event that the battery has been connected to a charging module by another user who was authorized to do so. In an embodiment, the operator is also prevented from using the battery in an electric work vehicle in an event that the battery has been mounted in the electric work vehicle by another user who was authorized to do so. The operator is therefore prevented from using the battery in an electric work vehicle, charging the battery, removing it from the electric work vehicle, and removing it from a charging module.

Detected access to the battery is unauthorized access where a biometric identifier has not been collected, or where a biometric identifier has been collected and the collected biometric identifier does not match an authorized operator from the list of authorized operators.

In an event that the battery is enabled for an operator, that operator may then be linked to the battery. As described above, this is used to enable access to the battery. It may also be used to collect data, for example on the usage patterns of batteries (frequency and length of use, location, or other data).

In an embodiment, the battery may comprise a battery identifier. The battery identifier may be used in combination with the biometric identifier to process whether the operator associated with the biometric identifier may use or access the battery. The list of authorized operators may be associated with the battery identifier.

The battery identifier may associate the battery with the operator and/or an electric work vehicle being operated by the operator. The battery identifier may be used to track the battery. The battery identifier may be communicated to the machine and/or to a central database via a communication module on the battery. The communicated battery identifier may be associated with the biometric identifier and stored on the electric work vehicle and/or at the central database. The communicated battery identifier may be associated with the electric work vehicle and stored on the electric work vehicle and/or at the central database. The battery identifier may assist in keeping track of which electric work vehicles the battery is used in, and which operators are using the battery.

In an embodiment, in the event that access to the battery is authorized for the operator, the battery identifier may be communicated to an electric work vehicle (for example an electric work vehicle being used by the operator) so that the electric work vehicle allows the battery to be mounted. For example, the communication of the battery identifier to the electric work vehicle may unlock a physical or software interlock on the electric work vehicle to allow the battery to be mounted in a battery compartment of the electric work vehicle, and connect to the electric work vehicle.

In an embodiment, the biometric identifier may comprise an image of the operator's face, wherein the biometric identification device comprises a facial recognition device. For example, the biometric identification device comprises a camera. In another embodiment, the biometric identifier may comprise a fingerprint of the operator, wherein the biometric identification device comprises a fingerprint reader.

In an embodiment, the biometric identification device may be integrated on the battery. In another embodiment, the biometric identification device may be a smart phone or other device that is configured to wirelessly communicate with the electric work vehicle. In this embodiment, the step 130 of enabling access to the work vehicle and step 140 of activating the operator profile may comprise sending a wireless signal to the electric work vehicle. The step 130 of enabling access may be based on proximity, for example between the biometric identification device and the battery. The biometric identification device may also be integrated onto at least one of the electric work vehicle and the charging module.

The battery may further comprise a location tracker configured to track the location of the battery. This may collect data for use in analysis of battery use or operator activity (as the operator is linked to the battery once access is enabled). The location may be transmitted, aiding security measures by allowing the location of the battery to be monitored. The location may be linked to the battery identifier.

The battery may further comprise a communication module configured to transmit the notification of unauthorized access. This allows unauthorized access to be detected in real time by a user, for example site manager or battery manager. The communication module may be further configured to transmit a notification of unauthorized change of location of the battery based on information recorded by the location tracker. An unauthorized change of location is a detected change of location where either a biometric identifier has not been collected, or a biometric identifier has been collected and the collected biometric identifier does not match an authorized operator from the list of authorized operators. The communication module may be further configured to transmit the battery identifier with the notification of the unauthorized change of location of the battery.

The battery may further comprise an accelerometer configured to detect movement of the battery. The communications module may be configured to transmit a notification of unauthorized movement of the battery. Unauthorized movement of the battery is a detected movement where either a biometric identifier has not been collected, or a biometric identifier has been collected and the collected biometric identifier does not match an authorized operator from the list of authorized operators. The communication module may be further configured to transmit the battery identifier with the notification of unauthorized movement of the battery.

The battery identifier may comprise data relating to the battery. For example, the battery identifier may comprise one or more of a battery owner, a battery type, charging requirements, and age of the battery.

The list of authorized operators may be controlled remotely via telematics.

Access to the battery may be enabled and prevented via an interlock. The interlock may comprise at least one of a physical interlock and a software interlock. The battery may comprise the interlock, such that the battery is disabled when not mounted on an electric work vehicle unless access is enabled via the biometric identification device. The interlock may be controlled by the biometric identification device.

At least one of the charging module and the electric work vehicle may also comprise an interlock that can enable and prevent mounting or removal of the battery from the charging module or the electric work vehicle. The interlock on the charging module or electric work vehicle may be controlled via the biometric identification device. The interlock on the charging module or electric work vehicle may be controlled via proximity to the battery (wherein access to the batter has been enabled or prevented).

According to an embodiment of the present disclosure, there is a security device for a battery for an electric work vehicle. The security device comprises a biometric identification device. The security device is configured to collect a biometric identifier from an operator using the biometric identification device. The security device is further configured to check the biometric identifier against a list of authorized operators. In the event that the operator matches an authorized operator from the list of authorized operators, the security device is further configured to enable access to the battery such that the operator is able to use the battery, remove of the battery from the electric work vehicle and a charging module, and mount of the battery into the electric work vehicle. In the event that the operator does not match an authorized operator from the list of authorized operators, the security device is further configured to prevent access to the battery such that the operator is prevented from using the battery, removing the battery from the electric work vehicle and a charging module, and mounting the battery into the electric work vehicle. The security device is further configured to detect access to the battery and transmitting a notification in the event that a biometric identifier has not been collected or the collected biometric identifier does not match an authorized operator from the list of authorized operators.

The security device may be further configured to carry any of the methods described above.

1. A method of securing a battery for an electric work vehicle, the battery comprising a biometric identification device, wherein the method comprises:
collecting a biometric identifier from an operator using the biometric identification device;
checking the biometric identifier against a list of authorized operators;
in an event that the operator matches an authorized operator from the list of authorized operators, enabling access to the battery such that the operator is able to:
use the battery;
remove the battery from the electric work vehicle;
mount the battery into the electric work vehicle; and
connect the battery to and disconnect the battery from a charging module;
in an event that the operator does not match an authorized operator from the list of authorized operators, preventing access to the battery such that the operator is prevented from:
using the battery;
removing the battery from the electric work vehicle;
mounting the battery into the electric work vehicle; and
connecting the battery to and disconnecting the battery from a charging module;
detecting access to the battery and transmitting a notification of unauthorized access in the event that access is detected and:
a biometric identifier has not been collected; or
the collected biometric identifier does not match an authorized operator from the list of authorized operators.

2. The method of claim 1, wherein the battery further comprises a battery identifier.

3. The method of claim 2, wherein the list of authorized operators is associated with the battery identifier.

4. The method of claim 2 wherein the battery identifier is configured to associate the battery with at least one of:
the operator; and
an electric work vehicle being operated by the operator.

5. The method of claim 2 wherein the battery further comprises a communications module configured to communicate the battery identifier to at least one of an electric work vehicle used by the operator and a central database.

6. The method of claim 1 wherein the biometric identification device comprises one of a facial recognition device and a fingerprint reader.

7. The method of claim 1 wherein the battery further comprises a location tracker configured to track the location of the battery.

8. The method of claim 1 wherein the battery further comprises a communication module configured to transmit the notification of unauthorized access.

9. The method of claim 5 wherein the communication module is further configured to transmit a notification of unauthorized change of location of the battery in the event that a change of location is detected and:
a biometric identifier has not been collected; or
the collected biometric identifier does not match an authorized operator from the list of authorized operators.

10. The method of claim 5 wherein the battery further comprises an accelerometer configured to detect movement of the battery, wherein the communication module is further configured to transmit a notification of unauthorized movement of the battery in the event that movement is detected and:
a biometric identifier has not been collected; or
the collected biometric identifier does not match an authorized operator from the list of authorized operators.

11. The method of claim 1 wherein the list of authorized operators is controlled remotely via telematics.

12. The method of claim 1 wherein access to the battery is enabled and prevented via one of a software interlock and a physical interlock.

13. The method of claim 1 wherein the biometric identification device is one of:
a smartphone; and
an on-board device mounted on the electric work vehicle.

14. A security device for a battery for an electric work vehicle, the security device comprising a biometric identification device, wherein the security device is configured to:
collect a biometric identifier from an operator using the biometric identification device;
check the biometric identifier against a list of authorized operators;
in the event that the operator matches an authorized operator from the list of authorized operators, enable access to the battery such that the operator is able to:
use the battery;
remove of the battery from the electric work vehicle and a charging module; and
mount of the battery into the electric work vehicle;
in the event that the operator does not match an authorized operator from the list of authorized operators, prevent access to the battery such that the operator is prevented from:
using the battery;
removing the battery from the electric work vehicle and a charging module; and
mounting the battery into the electric work vehicle;
detect access to the battery and transmitting a notification in the event that:
a biometric identifier has not been collected; or
the collected biometric identifier does not match an authorized operator from the list of authorized operators.

15. The security device of claim 14 wherein the battery further comprises a battery identifier.
